(19) United States
(12) Patent Application Publication
(10) Pub. No.: US 2023/0331249 A1
(43) Pub. Date: Oct. 19, 2023

(54) Teaching Trajectories in a Motor Vehicle

(71) Applicant: Volkswagen Aktiengesellschaft, Wolfsburg (DE)

(72) Inventors: Jana Seeland, Wolfsburg (DE); Christian Hopp, Wolfenbüttel (DE); Eugen Dick, Berlin (DE)

(73) Assignee: Volkswagen Aktiengesellschaft, Wolfsburg (DE)

(21) Appl. No.: 18/044,275

(22) PCT Filed: Aug. 19, 2021
(86) PCT No.: PCT/EP2021/073096

§ 371 Date: Mar. 7, 2023

(30) Foreign Application Priority Data
Sep. 8, 2020 (DE) 10 2020 211 260.6

(51) Int. Cl. B60W 60/00; B62D 15/02

(52) U.S. Cl. CPC B60W 60/001; B62D 15/021; B60W 2510/20; B60W 2555/20

(57) ABSTRACT

The disclosure relates to a method for operating a motor vehicle, comprising operating the motor vehicle in a teaching mode in which a driver can drive along and thereby teach a trajectory; and operating the motor vehicle in a following mode in which the motor vehicle at least semi-autonomously follows the trajectory or an adapted variant thereof. In the teaching mode, a maximum adjustable steering angle can be limited, and this limitation of the steering angle can be variably specified depending on a driving situation.

### CROSS-REFERENCE TO RELATED APPLICATIONS

This application claims priority to German Patent Application No. DE 10 2020 211 260.6, filed on Sep. 8, 2020 with the German Patent and Trademark Office. The contents of the aforesaid Patent Application are incorporated herein for all purposes.

### TECHNICAL FIELD

The invention relates to a control unit and a method for operating a motor vehicle. The motor vehicle may for example be a passenger car or a truck. In general, the invention relates to the field of at least semi-autonomously helping drivers of a motor vehicle execute desired driving maneuvers.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

DE 10 2014 220 144 A1 teaches that it is important for the vehicle to have a comparatively large steering angle to autonomously drive or follow the trajectory. This is needed, for example, to compensate for control differences. If the driver has already adjusted correspondingly large and in particular maximum steering angles while teaching, the leeway correspondingly decreases to compensate for control differences or adjust sufficiently large additional steering angles is correspondingly less when autonomously following the trajectory.

DE 10 2014 220 144 A1 therefore proposes limiting the adjustable steering angle during teaching mode, for example with a counter torque in the steering system generated in a timely manner.

It has been shown that such a solution can, from the perspective of the driver, result in a loss of comfort and, more precisely, steering behavior during teaching mode that is perceived as unnatural.

### SUMMARY

A need exists to improve the teaching of trajectories from the driver's perspective.

The need is addressed by the subject matter of the appended independent claims. Various embodiments are provided in the dependent claims, the following description, and the drawings.

### BRIEF DESCRIPTION OF THE DRAWINGS

FIG. 1 shows a vehicle in a schematic plan view that is operated in teaching mode and has a control unit according to an example embodiment.

FIG. 2 is a schematic representation of the subsequent adaptation of the trajectory taught according to FIG. 1.

FIG. 2A is a schematic representation of the subsequent adaptation of an alternative trajectory.

FIG. 3 is a flow chart of a method according to an example embodiment which is executed by the control unit from FIG. 1.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

It has been recognized that a driver can experience the steering behavior of a motor vehicle as unnatural due to the previously fixed limitation of the adjustable steering angle in teaching mode. Expressed otherwise, due to the artificially limited steering angle, the driver may experience the steering behavior in teaching mode as an unnatural deviation from the steering behavior of the motor vehicle in normal driving during which there are typically no corresponding limits.

In contrast to the prior art and in some embodiments, it is proposed to check the actual need for a steering angle limit in teaching operation (hereinafter also referred to as teaching mode), and/or dynamically adapting a steering angle limit to a current driving situation. Expressed otherwise, the steering angle limit is for example only provided when it is actually needed. A corresponding need can result when, if possible, additional steering angle reserves should still be available when following the taught trajectory in comparison to teaching mode, for example in order to be able to compensate for control differences when following the trajectory. However, embodiments provide investigating whether a taught trajectory can be subsequently adapted and/or modified in the knowledge of a current driving situation in such a way that at least partially autonomous following of the trajectory is subsequently possible even without corresponding steering angle reserves, or with at least reduced steering angle reserves. It is then not necessary to limit the steering angle directly in teaching mode, or such a limit can be reduced.

In particular, a method is proposed for operating a motor vehicle comprising:
operating the motor vehicle in a teaching mode (or also teaching operation) in which a driver can drive and thereby teach a trajectory;
operating the motor vehicle in a following mode in which the motor vehicle at least semi-autonomously follows the trajectory or an adapted variant thereof (for example subsequently by smoothing);
   wherein, in the teaching mode, a maximum adjustable steering angle can be limited, and this limitation of the steering angle can be variably specified depending on a driving situation.

To teach the trajectory and follow it, all of the conventional approaches in the prior art can be used. For example, a start position and/or a target position can be saved for teaching purposes. Furthermore, speed profiles, steering angles and/or time-dependent location information can be saved to describe the trajectory, in particular in a section of the route between the start position and the target position.

To follow or in other words drive this trajectory, the motor vehicle can adjust the corresponding steering angles and/or speeds at least semi-autonomously depending on the location. For this purpose, a control device can access or control corresponding actuators in the vehicle by evaluating the information taught and, in particular, saved in teaching mode.

A steering angle can be understood to be any angle size that describes steering behavior of the motor vehicle. For example, it can be a steering wheel angle, or a wheel steering angle measured at the vehicle's wheels. A rack position or a general operating variable of a steering system, from which the corresponding steering behavior of the motor vehicle (hereinafter also referred to simply as the vehicle) can be inferred, can also be used as the steering angle.

Conventional approaches in the prior art can be used to limit the steering angle. For example, an electromotive counter torque can be applied that acts against the steering movement provided by the driver (for example on a rack in an electromechanical steering system). In the case of a steer-by-wire system, a reaction force actuator can generate a corresponding counter torque, and/or an actuator coupled to the rack can refrain from converting a steering wheel angle into a corresponding steering movement at the vehicle wheels.

Correspondingly, to limit the steering angle, at least one steering apparatus of the motor vehicle can be controlled and/or can output control signals to bring about the limitation.

This control apparatus can furthermore detect a driving situation according to any of the approaches described below. Depending on the detected driving situation, the steering angle limit can be changed and thereby dynamically adapted to the current driving situation.

The steering angle limit can have at least two states, i.e., an unlimited state and a limited state. In the unlimited state, the maximum adjustable steering angle can correspond to a maximum possible steering angle, e.g., technically, and/or mechanically, and/or due to the system. In the limited state, the steering angle can assume a valve below said maximum possible steering angle. Expressed otherwise, a limit of the maximum possible steering angle can be selectively activated or deactivated, which corresponds to a variable establishment of the steering angle limit. In particular, these states can be switched depending on the currently present driving situation.

Generally, when basically unlimited maneuverability of the vehicle exists as the driving situation since, for example, there are no obstacles in the vehicle's surroundings, a limitation of the steering angle can be dispensed with, and/or it can be generally less. In this case, it can be assumed that the trajectory to be followed is adaptable such that it can be driven with a steering angle below the maximum possible steering angle. The remaining difference between the required steering angle to drive the adapted trajectory and the maximum possible steering angle then remains as still available leeway to vary the steering angle to compensate for any arising control differences.

If in contrast the maneuverability of the vehicle is impaired, for example due to obstacles in the vehicle's environment and/or the presence of so-called bottlenecks, the steering angle limit can be activated. The maximum adjustable steering angle is then for example below a maximum possible steering angle. This takes into account the fact that the trajectory is only subsequently adaptable to a reduced extent or not at all due to the slight remaining maneuvering leeway. Consequently, it also cannot be ensured that, by adapting the trajectory, the required steering angle to follow same can be reduced, and the described steering angle leeway remains to compensate for any control differences.

The solution presented here is generally beneficial in that the steering angle limitation is more needs-based. In particular, it can only be activated when it is actually needed to ensure that a taught trajectory is followed with sufficient precision. From the driver's perspective, this improves the steering behavior of the vehicle in teaching mode since it is felt to be less restricted.

Some embodiments provide that the driving situation is detected (and/or evaluated) using at least one of the following:
an environmental sensor system of the motor vehicle, for example comprising at least one radar sensor, one lidar sensor, one distance sensor, one ultrasonic sensor, or one camera;
a communication system of the motor vehicle (in particular a so-called Car2X communication system) that is configured to communicate with at least one vehicle-external unit, for example with another vehicle, with a mobile subscriber, with a server apparatus, or with an Internet service;
map information (for example saved in a navigation system of the vehicle or retrievable from an external server) that describes an environment of the vehicle;
a computer-implemented model, in particular a machine learning model, that is configured to ascertain a determination of the steering angle limit;
a computer-implemented method for evaluating and/or classifying the driving situation.

Each of the aforementioned variations can be used to evaluate the free maneuverability of the motor vehicle. Expressed otherwise, the driving situation can be significantly defined and/or evaluated by the extent to which the vehicle can freely maneuver, i.e., the extent to which obstacles are within the vicinity of the vehicle that will limit (free) maneuverability.

By means of the environmental sensor system, general obstacles in the environment of the vehicle can be detected, and/or open spaces can be detected. In general, the environmental sensor system can map the environment of the vehicle in a known manner.

With the communication system, the motor vehicle can obtain information that for example defines current maneuverability or general degrees of freedom of the movement of the motor vehicle. For example, it can obtain information from a control apparatus of a parking garage concerning occupation of parking spaces, the presence of bottlenecks within the parking garage, or generally lane boundaries within the parking garage. The same is also possible with regard to individual parking lots or parking spaces that are not a multilevel parking garage.

The map information can analogously relate to information that defines degrees of freedom of movement of the motor vehicle, for example due to a traffic infrastructure and/or general traffic routes at the location of the motor vehicle. The vehicle environment can be described using the map information, i.e., in particular as to whether there are options for turning, whether road branches are present, whether road narrowings exist, or generally what the space conditions are along a roadway, e.g., due to structural restrictions.

The model and in particular the machine learning model can be implemented in a control apparatus of the motor vehicle, wherein the control apparatus is a computer. It can however also be implemented in a vehicle-external computer apparatus and then, however, for example transmit investigation results relating to the steering angle limits to a control apparatus of the motor vehicle (for example by mobile radio). The model and in particular machine learning model can obtain information relating to the driving situation of the motor vehicle. In particular, the model and in particular machine learning model can obtain any of the information described herein by means of which the vehicle environment and/or the driving situation can be described. In particular, the model and in particular machine learning model can obtain information from said environmental sensor system, the communication system, and/or map information. The model and in particular machine learning model can use such information as an input variable. It can output a determination of the steering angle limit as an output variable. In particular, it can output whether the steering angle limit is or is not to be activated (for example whether the above described limited or unlimited state should be activated). Alternatively or in addition, it can output an extent of the steering angle limit, for example the value that the maximum adjustable steering angle should specifically assume.

Instead of a computer-based model, a general computer-implemented method and/or method for detecting and in particular evaluating and/or classifying the driving situation can be used. Steering angle limits can generally be determined by a characteristic curve, characteristic diagram, or table values.

The optional machine learning model can be trained and/or created based on training data records as well as within the context of a machine learning process. These training data records can describe driving situations and steering angle limits that exist therein. For example, the driving situations can be objective and for example verified in which steering angle limits were or were not considered appropriate. On the basis of such training data records, the machine learning model can learn a relationship that exists between a driving situation, or the variables describing the driving situation, as well as steering angle limits felt to be objectively appropriate.

In general, the model and in particular machine learning model can mathematically model a relationship between input variables and output variables. In the context of the learning or training process, links between these variables and/or weightings and the variables and/or so-called intermediate layers can be defined, established or, in other words, learned. In a manner known per se, the machine learning model can link the input variables and output variables across different layers, wherein the layers each have nodes that are linked by links to nodes of an adjacent layer. In particular, the machine learning model can be an artificial neural network or can be based thereupon.

In general, at least one driving situation parameter can be obtained that describes the current driving situation. Within the context of the method, it can be provided to check whether the driving situation parameter fulfills a predetermined steering angle limit criterion. If this is the case, the steering angle limit can be activated and/or limited to a predetermined value (in particular a value below a maximum possible steering angle). If this is not the case, a corresponding limit can be dispensed with. The driving situation parameter can for example be a minimum distance of the motor vehicle to the environment and/or to obstacles in the environment.

Alternatively or in addition, the driving situation parameter can, for example, be a classifier that is stored in a map and/or is generally location-dependent, or can comprise same. This can for example describe a level of difficulty of a current location, of a driving situation there, and/or a locally required driving maneuver, for example at a narrow point. Such parameters and in particular classifiers can be transmitted to a control unit executing the method, and/or can be determined or read out thereby. Software interfaces for map information and/or vehicle-external map servers such as map/Car2X can be used for this purpose.

For example, the need for a steering angle limit can be recognized or learned by the method and/or control unit, and the information or parameters required to determine the extent of the steering angle limit may for example be obtained via the above software interface. This information may optionally be linked to the size of the vehicle (for example, no or comparatively smaller steering angle restrictions may be needed for small vehicles).

In particular, some embodiments provide that the maximum adjustable steering angle is fixed at a reduced value or kept at a predetermined value below a (system-related and/or technically feasible) maximum possible steering angle if the driving situation corresponds to maneuvering the motor vehicle while not maintaining a minimum distance to interfering contours in the environment. An interfering contour in the environment can generally be understood to be a collision-relevant structure and/or a collision-relevant obstacle or object in the environment. It can in particular be constructed structures such as walls or pillars. Alternatively or in addition, the interfering contour can be classified, i.e., the steering angle limit can depend on the type or class of the interfering contour from which a minimum distance was undershot. For example, fixed obstacles such as walls or pillars can lead to a stronger restriction of the steering angle than, for example, vehicles stopped on a route that would probably no longer be stationary when driving in the future in following mode.

If the minimum distance to such a structure is undershot, the possibility of subsequently changing a learned trajectory decreases. Such a change can then cause the vehicle to run the risk of colliding with the interfering contour while following the adapted trajectory. Correspondingly, the taught trajectory should be driven as closely as possible, which is why a limitation of the steering angle is beneficial to compensate for subsequent control differences.

Alternatively or in addition, it can be provided that the maximum adjustable steering angle is fixed at a greater value or held at a predetermined value when the driving situation corresponds to maneuvering at a minimum distance to interfering contours and the environment.

The aforementioned greater and lesser values refer to changes in the maximum adjustable steering angle in comparison to driving situations that existed before a currently considered driving situation. In particular, starting can first commence without a steering angle limit, and then the maximum adjustable steering angle can be reduced. Likewise, however, a previously limited maximum adjustable steering angle can be changed to a correspondingly greater value with a lesser or no limit.

If the minimum distance to interfering contours in the environment is maintained, the maximum adjustable steering angle can in particular be increased to the (e.g., system-related and/or technical) maximum possible steering angle. This corresponds to deactivating the steering angle limit since the maximum possible or available steering angle limit is available. The maximum adjustable steering angle (i.e., the steering angle that can be adjusted or specified by the driver) then corresponds to the system-related or technically maximum possible steering angle.

The maintenance of minimum distances to interfering contours can then be evaluated by using the environmental sensor system as well as by using map information when this is matched with a current position of the vehicle. Likewise, the presence and/or location of interfering contours in the environment, if they exist, can be transmitted to the motor vehicle by the communication system of the motor vehicle, and then the minimum distance to these interfering contours can be checked.

As discussed, it can be provided that a taught trajectory is at least partially adapted before following. This can in particular be done when the steering angle has not been limited in teaching mode in the corresponding section, and/or a greater value of the steering angle was fixed. From the above-described reasons, the trajectory can be adapted such that it can be followed with reduced steering angles to ensure the possibility of compensating for control differences. Expressed otherwise, the trajectory can be smoothed.

One possibility for this is to increase at least one curve radius (or in other words radius of curvature) of the trajectory. In addition or alternatively, a turning-in point (in particular in front of a corresponding curve or curvature) can be shifted to the front along the trajectory, for example, or a turning-out point (e.g., from a curve and/or curvature) can be shifted to the rear along the trajectory. The direction designations front and rear refer to a direction of travel from a starting position of the trajectory to a target position (where positions more to the front are shifted in the direction of the target position). The turning-in point and turning-out point can be distinguished in that a steering angle at that location is changed beyond a specified threshold value. For example, a criterion can also be defined in that this change or the steering angle adjusted therewith is maintained over a certain driving distance, and/or is at least not reduced beyond a predetermined extent. For example, the turning-in point can be distinguished in that a greater steering angle is adjusted in comparison to straight-ahead driving or driving with a slight steering angle. The turning-out point can be distinguished in that the steering angle is reduced in comparison to driving with a greater steering angle or generally driving in a curve, and in particular driving with a smaller curve radius follows.

The corresponding shift of the steering-in points or steering-out points constitutes a simple way to smooth the trajectory. In particular, this reduces the risk of the driver perceiving the adaptation of the trajectory as unnatural or as an inappropriate deviation from the actually taught trajectory.

In general, it can be provided in this context that the trajectory is adapted depending on the environmental information detected in teaching mode. In particular, the environment can be mapped in teaching mode, for example by detecting the environment by means of the environmental sensor system. In this way, the adaptation can take into account relevant and/or current environmental conditions. The environmental information can for example be taken into account in such a way that there is a check of whether shifts in the turning-in point and/or the turning-out point or, in general, a changed curve radius will lead to collision hazards with the vehicle's environment.

Alternatively or in addition to the teaching mode, corresponding environmental information can also be obtained by any other versions described herein. For example, this can be obtained from a communication system of the vehicle, or also by using map information.

In summary, maximum permissible adaptations to the trajectory can be defined by using the environmental information. In addition or alternatively, planned adaptations to the trajectory based on the environmental information can be checked with respect to collision hazards resulting from the adaptations. If there are no collision hazards, the adjustment can be evaluated as permissible. If, in contrast, a collision hazard is detected, the adaptation may be evaluated as invalid and may not be implemented.

Some embodiments relate to a control unit for a motor vehicle, which is configured to carry out a method as discussed herein. The control unit can be configured to obtain information relating to the driving situation from all of the units described herein. For example, it can be connected to the environmental sensor system of the motor vehicle, to any communication system, or to a unit that provides map information. Likewise, the control unit can execute the described machine learning model or be connected to an apparatus that executes this machine learning model. Moreover, the control unit can be configured to output parameters and in particular control signals relating to the steering angle limit. For example, it can actuate an actuator of the steering system in order to determine and/or implement a steering angle limit. In particular, it can actuate an actuator to generate the counter torques described herein to thereby enable the steering angle limit.

In general, the control unit may comprise a processor and/or a memory. Program instructions can be saved in the memory and, when executed by the processor, can cause the control unit to execute a method according to any embodiment described herein.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

FIG. 1 shows a motor vehicle 10 (a passenger car) in a schematically highly simplified plan view. The vehicle 10 is in an environment 100 that is bordered by lateral constructed structures 102 from the vehicle's perspective. These constructed structures 102 form interfering contours in the vehicle's environment. They are for example walls of a parking garage. In the shown start position S, the vehicle 10 is at a comparatively large distance A from these interfering contours. Only by way of example, a single distance A is shown which could, however, also be defined as a distance circle around the vehicle 10 with the radius A, or it can assume any other contour that represents the distance A of the vehicle 10 from the points of the constructed structure that are relevant for the driving situation.

The vehicle 10 comprises a control unit 12. Moreover, it comprises an environmental sensor system 14 connected to the control unit 12 to transmit data. In the shown example, it has (only by way of example) two environmental sensors 16 that, for example, are distance sensors. For example, a plurality of corresponding environmental sensors 16 is provided in order to detect distances from the environment on all sides of the vehicle and thereby reliably map the vehicle environment with respect to interfering contours. In a manner known per se, for example the distances from the interfering contours 102 can be determined using the information (environmental information) detected by the environmental sensor system 14 as entered in FIG. 1 by the distance A.

For example, the control unit 12 is also connected by a data link D, indicated with a dashed line, to a vehicle-external server 104. This allows map information to be obtained from which environmental information can be derived. For example, a position, extent, and/or classification of interfering contours in the environment can also be inferred in this manner, for example a position of the walls 102. Knowing its own vehicle's position, the control unit 12 can also thereby determine distance information from the environment or from interfering contours there.

Alternatively or in addition, the server 104 can comprise or execute a machine learning model. To this end, it can obtain input variables from the control unit 12, for example a current vehicle position, or any environmental information detected by the environmental sensor system. Based on this, the necessity and/or the extent of a steering angle limit can be determined by the machine learning model knowing these input variables, and it can be output to the control unit 12.

It is not shown separately that the control unit 12 is connected to an actuator for limiting the steering angle. This can be any actuator mentioned in the general descriptive part with which a counter torque may for example be generated against manual torque exerted by the driver on the steering wheel (not shown).

In the shown state, the driver has activated a teaching mode, for example by a corresponding entry in a vehicle control system. A driven trajectory T that is indicated with a dashed line in FIG. 1 is recorded in a known manner during teaching mode, for example by the control unit 12. The trajectory T can be characterized by the steering wheel angle T adjusted by the driver depending on the location, or this steering wheel angle can be saved depending on the location. In the shown example, the vehicle 10 first enters an area B1. Using any of the above-described information and in particular environmental information, the control unit 12 determines whether there is sufficient vehicle 10 maneuverability. In particular, it is determined in this regard whether the distance A to the interfering contours in the environment (i.e., to the walls 102) is above a predetermined minimum value. This is the case in the area B1. The control unit 12 therefore determines that it is unnecessary to limit the steering angle. Given the lack of the limit, the maximum possible steering angle that can be adjusted by the driver therefore corresponds to a system-related maximum possible or available steering angle. Expressed otherwise, the driver can steer out the vehicle 10 in the area B1 to the maximum extent and without a limit while learning the trajectory T.

In an area B2 along the trajectory T, the distance from the environment or the walls 102 to the vehicle 10 decreases significantly. This is clear from the course of the driven trajectory in the area B2 and the significantly reduced distance to the walls 102 in comparison to the area B1.

This is determined by the control unit 12 whereupon a steering angle limit is activated. The driver can then no longer adjust the system-related maximum possible/available steering angle as the (manually) maximum adjustable steering angle. Instead, only a reduced maximum possible steering angle is available for him. In the shown example, this is continued until the target position Z is reached.

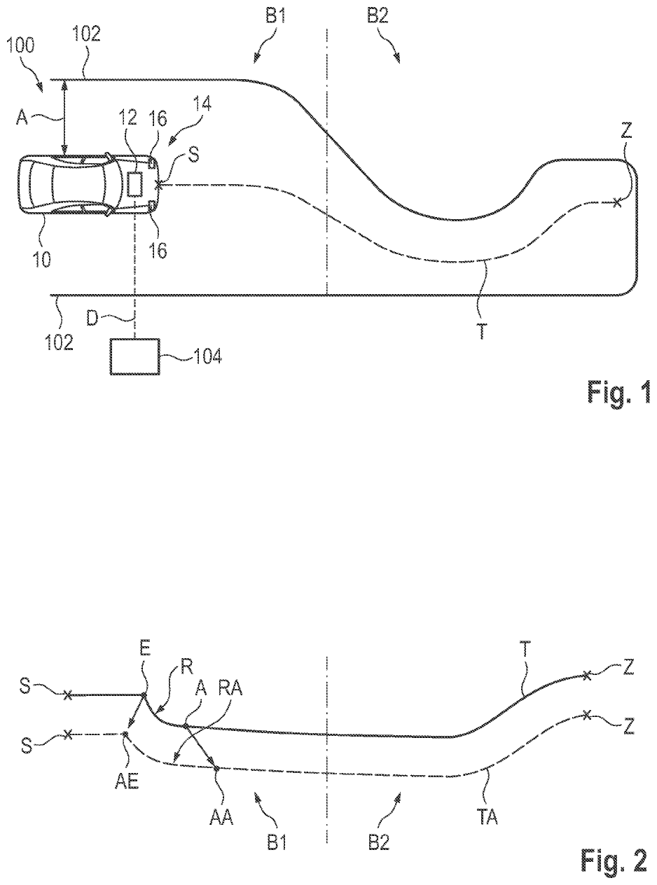

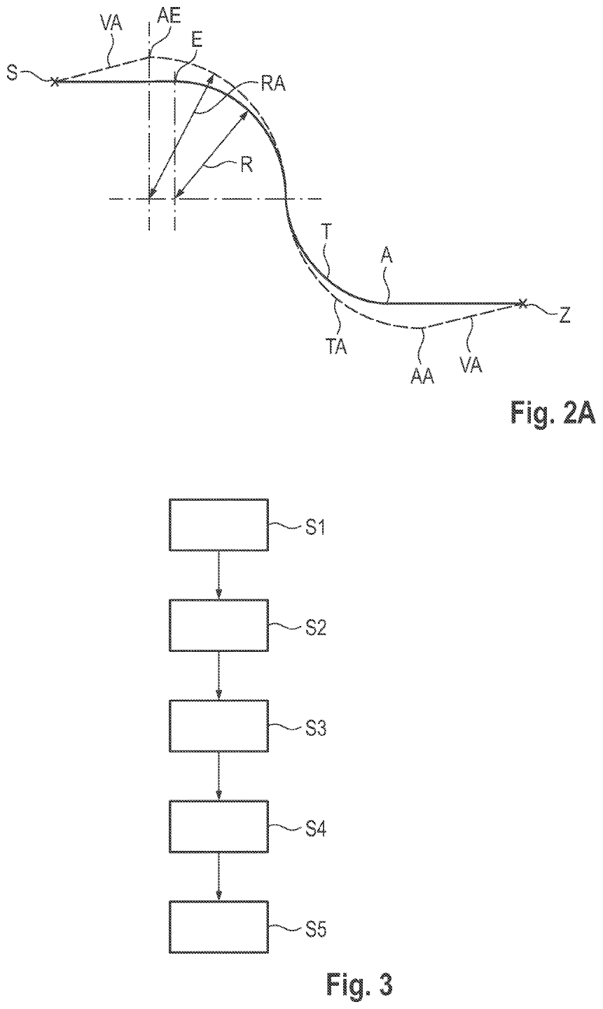

After teaching mode is over, the trajectory T is for example adapted by the control unit 12 or optionally by the external server 104. This process is shown schematically simplified in FIG. 2. First, the original trajectory T is shown as taught by the driver. This is also depicted in a dashed line. Also depicted is the course of an adapted trajectory TA that is shown in a dashed line. The illustration from FIG. 2 serves to clarify the different courses of the trajectory T, TA. The shown arrangement of these trajectories TA, T above and below each other is of no particular relevance. In particular, it is provided that these trajectories T, TA overlap as much as possible and are not consistently at a distance from each other as depicted only for reasons of illustration.

The areas B1 and B2 are shown in which there was no steering angle limit (B1) or a steering angle limit was activated (B2). There is for example no adaptation of the trajectory in the area B2 with a steering angle limit. In this case, it can be assumed that the vehicle still has a sufficient steering angle reserve available when autonomously following the trajectory, wherein this reserve corresponds at least to the difference between the limited adjustable steering angle in area B2 and the system-related/technically maximum available steering angle. In addition, the trajectory is not adjusted for safety reasons so as not to cause any collision hazard with the surroundings.

In contrast, there is no steering angle limit in area B1. As explained in the general part, this has the benefit that the driver perceives the steering behavior of the vehicle 10 as natural and unrestricted. However, this means that there is no steering angle reserve in autonomous driving mode in certain circumstances for compensating any occurring control differences. This holds true in particular in sections of the trajectory in which the driver has actually adjusted the maximum possible steering angle, i.e., for example turned the steering to the maximum extent. In the present case, such a full lock exists at the steering-in point marked E. The steering-in point E is distinguished by a change in the steering angle above a permissible threshold value, e.g. a change of more than 60%. Then, viewed in the direction of travel (i.e. from the starting point S to the target point Z), a curve is taken with the curve radius R along the trajectory T to the steering-out point A. From the steering-out point A, there is an opposite change in the steering angle, which in turn is for example above a certain threshold value, for example more than 60%.

The trajectory T is then adapted in such a way that steering angles required in the area B1 to drive the adapted trajectory TA are limited as much as possible. In particular, they are limited such that they are for example below a maximum possible steering angle, i.e., for example a full lock has not been assumed. This can ensure that a certain steering angle reserve still remains in order to adapt control differences when automatically driving the adapted trajectory TA.

In the present example, this is achieved in that the curve radius R in the curve section is increased between the steering-in point E and steering-out point A (to the adapted radius RA). This is accomplished in particular in that the steering-in point E is shifted further to the rear (that is, closer to the starting point S) along the adapted trajectory TA. This yields the adapted steering-in point AE of the adapted trajectory TA. In addition or alternatively, the steering-out point A is shifted further to the front along the adapted trajectory TA (that is, in the direction of the destination Z). This results in the shown adapted steering-out point AA.

Despite the lack of a steering angle limit in the area B1 which can be beneficial from the driver's perspective, sufficiently precise drivability of the taught trajectory T is thereby ensured in the form of the adapted trajectory TA.

FIG. 2A shows another alternative example of a trajectory adaptation in the event of a driven S-shaped trajectory or S-shaped curve. The trajectory T and its dashed adapted course TA are depicted overlapping, and the trajectory is adapted along its complete length. In this case, the adapted steering-in and steering-out points EE, AE do not just shift along the original trajectory T, but also in directions that are not parallel thereto. Accordingly, it may also be necessary to add connecting sections VA to the adapted trajectory TA that connect the starting and destination points S, Z to the adapted turning-in and turning-out points AE, EE.

FIG. 3 shows a flow chart of an exemplary method executed by the control unit 12 from FIG. 1.

In step S1, the teaching mode is activated, and the vehicle 10 begins to drive the trajectory T. In step S2 which can also be simultaneous, environmental information is obtained (for example by means of the environmental sensor system 14) and/or recorded while the trajectory T is being driven. In step S3, which is for example executed continuously while driving the trajectory T, the environmental information is used to determine whether a steering angle limit is required. For this purpose, the distance A from the environment or from the walls 102 is determined as a criterion, and/or other criteria are considered such as the classification of an interfering contour. If this is below a predetermined threshold value, the maneuverability of the vehicle 10 is restricted, and a steering angle limit is therefore activated. If this is not the case, there is no limitation of the steering angle. The activation or non-activation of the steering angle limit can be saved as additional information describing the trajectory T.

In step S4, the trajectory T is driven, and it is then analyzed. In the present case, this comprises determining the areas B1 and B2 with and without limiting the steering angle. In the area B1 with steering angle limitation, the adaptation, explained with reference to FIG. 2, of the trajectory T to the adapted trajectory TA is then performed. In step S5, the autonomous driving mode is activated, and this adapted trajectory TA is driven. There can be a significant time difference of several hours or days between the steps S1 and S5. In a manner known per se, the driver can therefore teach a parking procedure that, from his perspective, occurs frequently (e.g., with respect to a reserved parking space in a parking garage) in step S1, and have the vehicle 10 autonomously or independently follow (i.e., repeat) this parking procedure in step S5.

### LIST OF REFERENCE NUMERALS

10 Vehicle
12 Control unit
14 Environmental sensor system
16 Environmental sensor
100 Environment
102 Wall
104 Server
A Distance
B1 Area with steering angle limit
B2 Area without steering angle limit
S Starting point
Z Destination
T Trajectory
TA Adapted trajectory
E Steering-in point
A Steering-out point
AE Adapted steering-in point
AA Adapted steering-out point
D Data line
R Curve radius
RA Adapted curve radius
VA Connecting section

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for operating a motor vehicle, comprising:
operating the motor vehicle in a teaching mode in which a driver can drive and thereby teach a trajectory;
operating the motor vehicle in a following mode in which the motor vehicle at least semi-autonomously follows the trajectory or an adapted variant thereof;
wherein, in the teaching mode, angle limit of the motor vehicle is selectively adjustable depending on a driving situation.

2. The method of claim 1, comprising detecting a driving situation using at least one of the following:
an environmental sensor system of the motor vehicle;
a communication system of the motor vehicle that is configured to communicate with at least one vehicle-external unit;
map information that describes an environment of the vehicle;
a computer-implemented model that is configured to ascertain a determination of the steering angle limit; and
a computer-implemented method for evaluating and/or classifying the driving situation.

3. The method of claim 1, wherein the steering angle limit is fixed at a reduced value or set to a predetermined value below a maximum possible steering angle if the driving situation corresponds to maneuvering while not maintaining a minimum distance to interfering contours in the environment.

4. The method of claim 1, wherein the steering angle limit is fixed at a greater value or held at a predetermined value when the driving situation corresponds to maneuvering at a minimum distance to interfering contours in the environment.

5. The method of claim 1, comprising adapting the trajectory at least partially before following in order to generate the adapted variant.

6. The method of claim 5, wherein the adaptation comprises increasing at least one curve radius of the trajectory.

7. The method of claim 5, wherein the adaptation comprises shifting to the front at least one steering-in point, and/or shifting to the rear at least one steering-out point.

8. The method of claim 5, comprising adapting the trajectory taking into account environmental information detected in teaching mode.

9. The method of claim 8, wherein maximum permissible adaptations to the trajectory are defined by using the environmental information.

10. A control unit for a motor vehicle, which is configured to:
operating the motor vehicle in a teaching mode in which a driver can drive and thereby teach a trajectory;
operating the motor vehicle in a following mode in which the motor vehicle at least semi-autonomously follows the trajectory or an adapted variant thereof;
wherein, in the teaching mode, a maximum steering angle of the motor vehicle is selectively adjustable depending on a driving situation.

11. The method of claim 2, wherein the steering angle limit is fixed at a reduced value or set to a predetermined value below a maximum possible steering angle if the driving situation corresponds to maneuvering while not maintaining a minimum distance to interfering contours in the environment.

12. The method of claim 2, wherein the steering angle limit is fixed at a greater value or held at a predetermined value when the driving situation corresponds to maneuvering at a minimum distance to interfering contours in the environment.

13. The method of claim 3, wherein the steering angle limit is fixed at a greater value or held at a predetermined value when the driving situation corresponds to maneuvering at a minimum distance to interfering contours in the environment.

14. The method of claim 2, comprising adapting the taught trajectory at least partially before following in order to generate the adapted variant.

15. The method of claim 3, comprising adapting the taught trajectory at least partially before following in order to generate the adapted variant.

16. The method of claim 4, comprising adapting the taught trajectory at least partially before following in order to generate the adapted variant.

17. The method of claim 6, wherein the adaptation comprises shifting to the front at least one steering-in point, and/or shifting to the rear at least one steering-out point.

18. The method of claim 6, comprising adapting the trajectory taking into account environmental information detected in teaching mode.

19. The method of claim 7, comprising adapting the trajectory taking into account environmental information detected in teaching mode.
